(19) United States
(12) Patent Application Publication
(10) Pub. No.: US 2016/0164348 A1
(43) Pub. Date: Jun. 9, 2016

(54) ELECTROMAGNETIC ACTUATOR IN PARTICULAR INTENDED TO DRIVE A TURBOCOMPRESSOR RELIEF VALVE

(71) Applicant: SONCEBOZ AUTOMOTIVE SA, Sonceboz (CH)

(72) Inventor: Cédric MELLERE, Soulce Cernay (FR)

(73) Assignee: SONCEBOZ AUTOMOTIVE SA, Sonceboz (CH)

(21) Appl. No.: 14/908,390

(22) PCT Filed: Jul. 30, 2014
(86) PCT No.: PCT/EP2014/066385

§ 371 Date: Jan. 28, 2016

(30) Foreign Application Priority Data
Jul. 31, 2013 (FR) 13/57597

(51) Int. Cl. H02K 1/12; H01F 7/18; H01F 7/08

(52) U.S. Cl. CPC H02K 1/12; H01F 7/08; H01F 7/18

(57) ABSTRACT

An electromagnetic actuator is intended in particular to drive a relief valve for a turbo-compressor, the actuator including a fixed member formed by a first magnetic stator circuit made from a material with high magnetic permeability excited by at least one excitation coil, and a moving member made up of a thin part, the magnetised thin part being alongside a second magnetic circuit made from a material with a high magnetic permeability, the moving member being provided with a coupling axle, the fixed and moving members being attracted against one another under the combined magnetic effect of the magnetised part and the excitation coil, the fixed member and the moving member being connected by a mechanical connector with friction of the pure sliding type, the connector being a system, directly incorporated into the actuator, for mechanical damping of the outside disturbances applied to the valve, and the connector having a mechanical friction characteristic of the glued-sliding type dependent on the relative position of the moving and fixed members and on the current flowing in the coil.

### CROSS-REFERENCE TO RELATED APPLICATIONS

This application is a National Phase Entry of International Patent Application No. PCT/EP2014/066385, filed on Jul. 30, 2014, which claims priority to French Patent Application Serial No. 1357597, filed on Jul. 31, 2013, both of which are incorporated by reference herein.

### FIELD

The present invention relates to the field of rotary electromagnetic actuators intended in particular to drive a relief valve for a turbo-compressor for internal combustion engines, commonly called a “waste gate”. The invention specifically relates to electric actuators used to drive such relief valve and thereby control gas pressure in the turbo-compressor turbine.

### BACKGROUND AND SUMMARY

Heat engines (for motor vehicles, trucks, building machines . . . ) are operated by the explosion of an air/fuel mixture in the combustion chamber of the cylinders. The air loop of the motor, which aims at routing, managing and discharging the air supplied to the engine, operates using various valves. To improve heat engine performances, some vehicles are equipped with turbo-compressors which aim at supercharging the combustion chamber with air.

Such supercharging devices are generally equipped with mobile elements (variable geometry with rotary blades and crown, rotary valve wastegate, . . . ) controlling the operation and the effect of the turbo-compressors according to the engine speed and the detected load. Such moving mechanical elements are moved by (mainly pneumatic and electric) actuators driven by the computer aboard the vehicle. As the turbo-compressor moving mechanical elements are in the flow of the exhaust gas exiting the combustion chamber, they are subjected to pressure variations inducing resultant forces, the amplitude and the frequency of which directly depend on the heat engine operating speed.

The actuators driven by the computer aboard the vehicle and setting in motion the moving elements must be so dimensioned as to:
Drive, at any time, the moving element to the desired position (whatever the temperature and the load to be overcome)
Be able to reach the target position within a generally very short period of time (about 100 ms) to ensure the optimum operation of the turbo
Stably maintain this position with the lowest possible power consumption.

The German patent DE102011051560 which discloses a known exemplary relief valve for a turbo-compressor is known in the prior art. The patent WO2013017794, which discloses a compact positioning assembly comprising an actuator and a sensor integrated in the cylinder head of the actuator is also known. The German patent DE102011078907 discloses another exemplary exhaust back pressure valve for controlling the pressure of the flow of exhaust gas. The patents EP1804366 and U.S. Pat. No. 5,828,151 disclose other examples of rotary electromagnetic actuators.

Electric machines with frictional guiding as disclosed in the patent US2006244330 are also known in the prior art. This rotary machine comprises, between the fixed part and the moving part thereof, guiding elements which may be annular bearings but also friction bearings or rolling bearings. These guiding elements are not specifically described in the patent and those skilled in the art will understand that they only aim at enabling the relative rotation of the moving element relative to the fixed element of the machine with the lowest possible friction, so as to minimize mechanical losses and get high yields. These guiding elements provide no mechanical filtration function of the possible external disturbances applied to the moving element.

The patent US2011240893 which discloses a valve actuator with a plastic bearing is also known. A ferromagnetic hub includes specific forms receiving plastic in the form of perforated washers for receiving the motor shaft. The plastic used for such washers must have a low friction coefficient, preferably with nylon in order to reduce the sticking effect between the fixed part and the moving part of the actuator, in particular when the lubricating elements are no longer present to provide such function. The plastic washers having a low friction coefficient provide here only the function of positioning and guiding the shaft with the aim of reducing mechanical losses by using an economical solution. This solution does not make it possible to compensate and filter possible disturbances in or vibrations of the position of the moving element. In this patent, the plastic washers mainly have a radial function for maintaining the shaft and not an axial one.

Similarly, actuators, as shown in the patent EP1432106, wherein a bearing made of a soft magnetic material is fixed to the stator and where a part of the rotor shaft goes through, are known. This bearing is preferably made of a soft magnetic material having as low friction forces as possible. One of the characteristics of the material used to make this bearing is that it also prevents the adsorption caused by the magnetic forces generated between the stator and the rotor in order to preserve the rotational characteristics thereof and to improve the serviceability thereof. These bearings aim here at limiting the phenomena of wear or mechanical losses by using materials compatible with the magnetism of the actuator and limiting the friction phenomena. This solution does not make it possible to dampen and cancel the external disturbances which may affect the actuator position.

The patent U.S. Pat. No. 3,242,365 which discloses a voltage generation control system incorporating a system for damping the oscillations of the mobile stator system is also known. This damping system introduces friction through a soup dish-shaped (Belleville spring washer) spring constrained between a friction ring and the stator. The damping system may also be a leaf spring in contact with the stator or any other damping means such as heavy grease or friction pad. The damping system here is based on friction but requires a resilient constraining means to achieve the desired damping effect. Expensive, bulky and hardly controllable elements must therefore be integrated to achieve damping, such as “Belleville washer” type springs, elastic friction leaves or pads which have to be activated or constrained via elastic elements. Using heavy grease is also irrelevant because, on the one hand the damping effect will depend on the speed of the disturbances (low speed, slow disturbances will not be cancelled by a fluid such as grease) and, on the other hand, grease tends to lubricate the surfaces thus to reduce or even eliminate friction of the contacting surfaces, thus to reduce the frictional damping.

Heat engine supercharging systems make it possible to increase performances by increasing the pressure of the air admitted into the combustion chamber. As shown in FIG. 1 which illustrates the general operation of a “wastegate” type turbo-compressor of the prior art, turbo-compressors consist of:
a “Turbine” (1) part: the turbine is rotated by the passage of the exhaust gas.
a “compressor” (2) part: the compressor is mechanically rotated by the exhaust turbine (both are connected by one shaft), it supercharges air into the combustion chamber
a moving element (5): it makes it possible to control the rotation speed of the turbine (and thus the compressor action level) when activated, a portion of the exhaust gas bypasses the turbine without acting on the rotation thereof
an actuator (3): it drives the position of the moving element of the turbine part
a kinematic connection (4): it transmits the movements (position and force) of the actuator (3) to the moving element (5).

As can be seen in FIG. 2, the moving element (5) is subjected to two types of forces resulting from the action of the gas:
A constant effort shown by the arrow (7): its amplitude depends on the degree of opening and the pressure level of the gas acting on the moving element (5), but the amplitude remains constant over time. The orders of magnitude are about 2 bars.
A variable effort shown by the arrow (6) of the sinusoidal excitation type, the frequency of which directly depends on the engine speed (with each opening cycle of an exhaust valve inducing a pressure peak). The orders of magnitude are ±0.45 bar over a frequency range [20 Hz; 200 Hz]. These forces disturb the operation of the actuators known in the prior art, particularly during the closed loop position control.

The current state of the art provides many solutions of actuators, wherein the moving element is guided and moved relative to the fixed element by a friction system. Most solutions aim at minimizing the frictional losses through the use of specific materials and shapes. The few solutions relating to frictional oscillation damping are irrelevant for lack of performance or because of the complex and difficult implementation and execution in tight spaces such as the actuator described herein.

The actuators of the prior art (linear actuator or torque motor) are a particularly appropriate solution for demanding applications such as supercharge turbo-compressors. The main characteristics are compactness, robustness and high dynamics. As this solution is a direct drive system (no gear-type or any other reduction movement between the rotor and the output shaft of the actuator), it is very fast but is exposed, in return, to all the disturbances of the load it drives. Its low stiffness thus exposes it to potential instability in “closed loop” driving, especially for high frequency excitations.

The solution developed consists in directly integrating into the actuator a mechanical damping system capable of filtering the high frequency excitations experienced by the torque motor. The significant advantages of this type of actuator (compactness, robustness, dynamics) are thus preserved and the risk of instability is eliminated by adding stiffness to the actuator. The electromagnetic actuator according to the invention is able to drive the moving elements of turbo-compressors by ensuring and efficiently stable holding in position with a reduced power consumption of the actuator. The idea is to introduce into the actuator an element filtering the high frequency excitations which can be detected by the actuator.

It should be noted that the damping system of the invention is not intended to guide the moving element, but that it especially aims, in a rotary embodiment as described in the figures, at an axial holding and not a radial guiding. It is therefore directly subjected to efforts and axial compression loads, resulting from the magnetic attraction between the moving element and the fixed element and thus must solve a creep problem: its material and its dimensions must be carefully designed and selected (especially in terms of operating temperatures and mechanical stress) to avoid any risk of compaction which might affect the characteristics and performances of the actuator of the present invention. The plastic materials and the conventional integrations disclosed in the prior art are not sufficient to prevent this failure.

In the case of a rotary embodiment, the combination of an abutment washer used to damp a torque motor is extremely relevant for the operation of the actuator and the judicious choice of the place where it is integrated: no need for resilient constraining means, since the holding torque is greater than the disturbing torque thanks to the “stick-slip” effect and thanks to the characteristic of the actuator (minimum effort at the beginning of the stroke as a result of the field effect of the coils, therefore the movement can be easily initiated). For this purpose, the invention in its broadest sense, relates to an electromagnetic actuator intended in particular to drive a relief valve for a turbo-compressor, with said actuator comprising a fixed member formed by a first magnetic stator circuit made of a material with a high magnetic permeability excited by at least one excitation coil, and a moving member made up of a thin part, with said magnetised thin part being alongside a second magnetic circuit made of a material with a high magnetic permeability, with said moving member being provided with a coupling axle, with said fixed and moving members being attracted against one another under the combined magnetic effect of the magnetised part and the excitation coil, characterized in that the fixed member and the moving member are connected by a frictional mechanical connecting means of the pure sliding type, in that said connecting means is a system directly incorporated into the actuator, for mechanical damping of the external disturbances applied has a mechanical friction characteristic of the stick-slip type dependent on the relative position of the moving and fixed members and on the current flowing in the coil.

The actuator according to the invention may be a rotary actuator or a linear actuator. In the first case, the magnet will have the shape of an axially magnetised disc. In the case of a linear actuator, the magnet will have the shape of a thin rectangle magnetised in the thickness direction.

Preferably, said frictional mechanical connecting means consists of a thin part inserted between said moving member and said fixed member. Advantageously, said frictional mechanical connecting means has a static friction greater than the dynamic friction. Preferably, said mechanical connecting means is so configured as to exert a friction torque greater than or equal to the maximum variable disturbing torque detected by the torque motor.

According to a preferred embodiment, said frictional mechanical connecting means consists of a composite material of the metal/polymer type. Advantageously, said frictional mechanical connecting means has a structure comprising a rigid support made of polytetrafluoroethylene (PTFE)-coated steel containing a mixture of fibers. Preferably, said rigid support is sintered with a porous bronze layer impregnated and coated with a sliding layer. Advantageously, the actuator comprises a regulator which drives the actuator in a closed loop which instructs same to go slightly beyond a target position (to voluntarily go past a set point) in order to be able, right afterwards, to return to the target position in the direction of the load when the actuator moves the valve from an open position to a closed position; and in that the regulator which drives the actuator in a closed loop instructs same to slightly stabilize before such target position by voluntarily stopping ahead of the set point, to be able to reach, right afterwards, the target position in the direction of the load when the actuator moves the valve from a closed position to an open position.

### BRIEF DESCRIPTION OF THE DRAWINGS

The invention will be better understood upon reading the following description, referring to the appended figures illustrating a non-limitative embodiment wherein:

FIGS. 1 and 2 show an overall view of a turbo-compressor of the prior art;

FIG. 3a shows a partial cutaway view of an actuator according to the invention;

FIG. 3a shows a partial cutaway view of an actuator according to the invention;

FIG. 4 shows the change in the axial force acting on said frictional mechanical connecting means according to the angular position of the rotor of the actuator and the current supplied to the excitation coils;

FIG. 5 shows an example of quasi-static torque measurements of an actuator equipped with such a friction means;

FIG. 6 shows the response times curve at the 12V index; and

FIG. 7 shows the behavior of the actuator with a regulator, the driving strategy of which enables a significant reduction in the current consumption when holding the position.

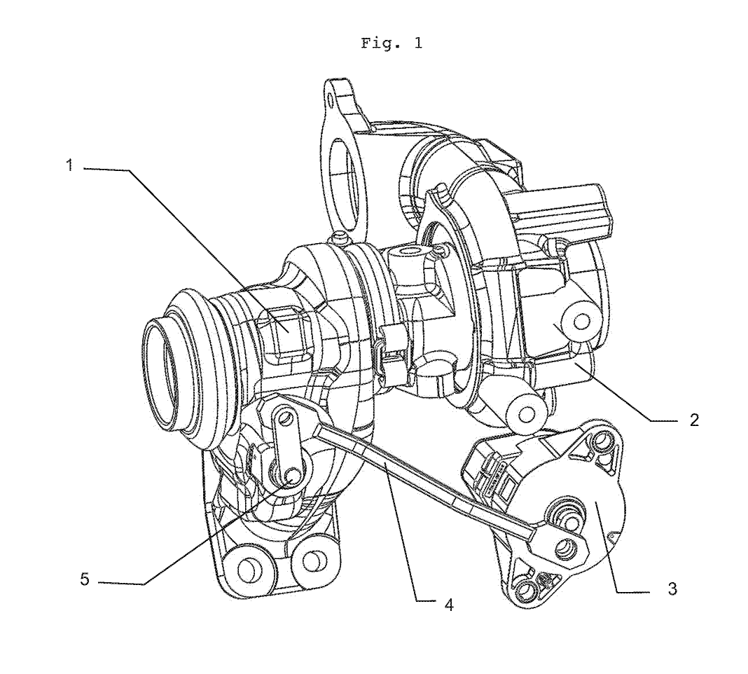

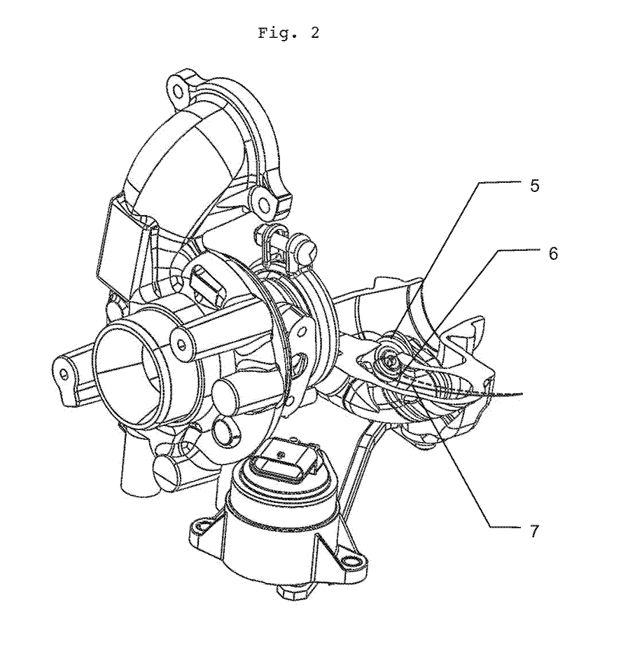

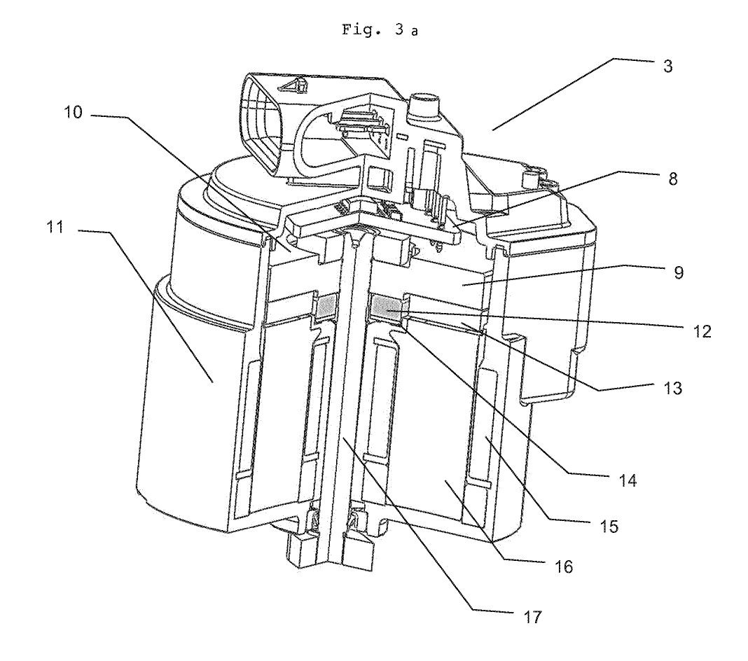

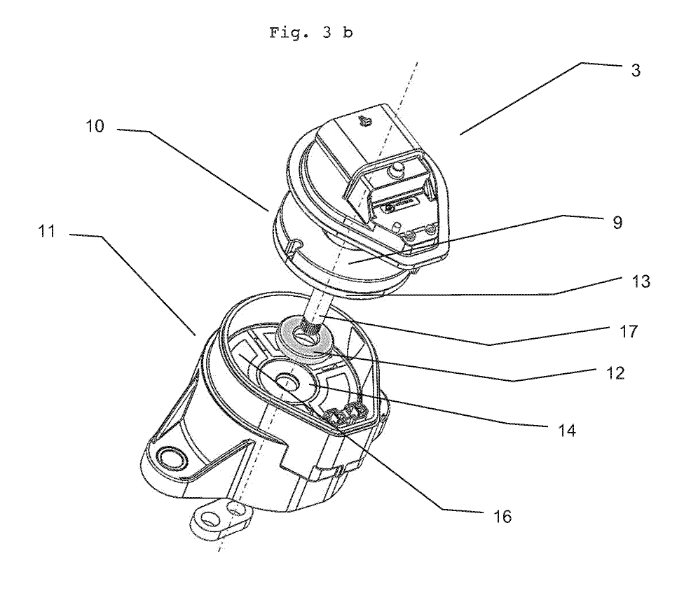

### DETAILED DESCRIPTION

The actuator 3 knowingly comprises a stator having stator teeth 16, at least some of which are surrounded by a coil 15. The rotor 10 consists of a steel disc 9 whereon a permanent disc-shaped magnet 13 is fixed. A printed circuit 8 carries the electronic components for processing the signals from the position sensor indicating the angle at which the rotor 10 is positioned. The stator 11 has a cavity 14 formed in a core of steel and/or plastic, which accommodates a friction ring 12 forming said frictional mechanical connecting means. This friction washer 12 is engaged between a friction surface (slip) with the rotor 10 and a friction surface (stick) with the stator 11, with both members (stator 11, rotor 10) being attracted against one another under the combined magnetic effect of the permanent motor magnet 13 fixed with the rotor 10 and the excitation coils 15 fixed with the stator 11. Such washer 12 is subjected to pure uni-axial compressive forces.

A thrust ball bearing which takes up the axial magnetic forces while minimizing friction losses is generally used in the prior art instead of such a washer 12. In the invention, the washer 12 introduces a certain level of friction, which will add the missing stiffness to the solutions of the prior art. A pure rolling connection is thus replaced by a pure sliding connection between the rotor 10 and the stator 11 of the actuator 3.

As an example (for an actuator supplied with 3.5 A at 25° C.), at the beginning of the stroke, the motor torque is 480 mNm for an axial force of 90N and at the end of the stroke the motor torque is 310 mNm for an axial force of 305N. The axial force without current is 195N. With a washer 12, the coefficient of friction of which is of the order of 0.075, an outer diameter of 17 mm and an inner diameter of 7 mm, it has been established that:
the maximum stress on the friction washer 12 at the end of the stroke is sigma=N/s=1.8 MPa
the friction torque at the beginning of the stroke is: C=F.Ravg.tan(α)=37.125 mNm
the friction torque at the end of the stroke is: C=F.Ravg.tan(α)=125.8 mNm
the friction torque without current is: C=F.Ravg.tan(α)=80.5 mNm

The selection of the material of the washer 12 is important. It must have “stick-slip” characteristics which are significant to ensure a high static friction. The “stick-slip” phenomenon refers to a jerky motion observed during the relative sliding of two objects. It can be explained by Coulomb's laws relative to friction. These laws involve static friction coefficients or adhesion coefficient (fo) and the dynamic friction coefficient or sliding friction coefficient (f).

The first (static) one acts when the sliding speed between two surfaces is zero: this is the case when it is desired to move a mass initially at rest. The second one comes into account when the sliding speed between the two surfaces is not zero: for instance when the mass pushed is already moving.

The force that must be exerted to move a given mass is proportional to such mass and to the considered static or dynamic coefficient, depending on whether the mass is at rest or not. If fo is greater than f, as recommended in the present invention, a greater effort shall be required to move the rotor 10 initially at rest than to keep it moving. This characteristic makes it possible to ensure a correct filtering of the high frequency disturbances for a good holding in position; and a low dynamic friction (little resistance to movement) so as not to affect the actuator performances 3 during the movement phases.

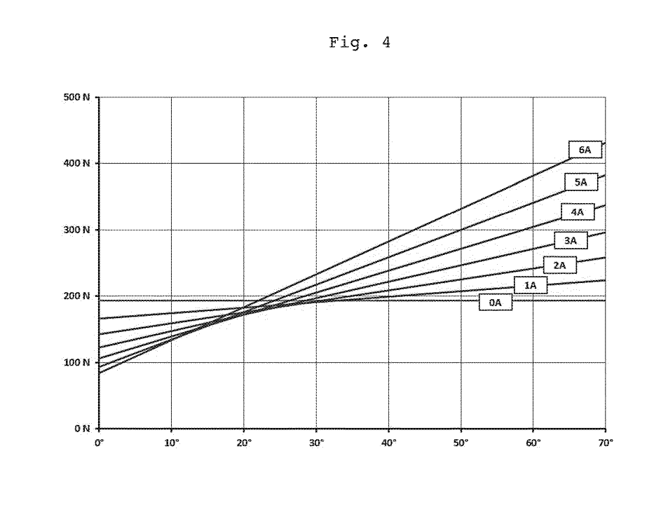

FIG. 4 shows the evolution of the axial force on the stroke. As the axial force is smaller at the beginning of the stroke (0°) than at the end of the stroke (70°), the following advantage is obtained: when it is desired to move the rotor 10 (moving from the beginning to the end of the stroke), the excitation coils 15 of the stator 11 are powered and the friction washer 12 will therefore be relieved (the axial force decreases because the magnetic flux of the stator 11 opposes that of the motor magnet 13) which results in an easier initiation of the movement and in switching from a high static friction to a lower dynamic friction, with the friction torque induced by the washer 12 being directly proportional to the axial stress which it is subject to.

The friction element 12 may consist of:
a washer entirely made of plastic material
a steel washer with a surface treatment making it possible to control the friction coefficient
a composite washer with a steel support base supporting a layer of impregnated sintered bronze coated with a polymer layer
a pair of two stacked washers made of steel, plastic or steel with a surface treatment

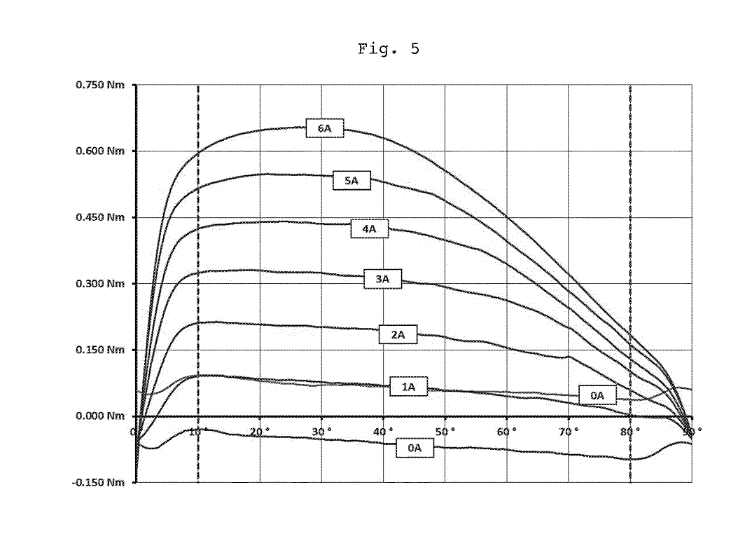

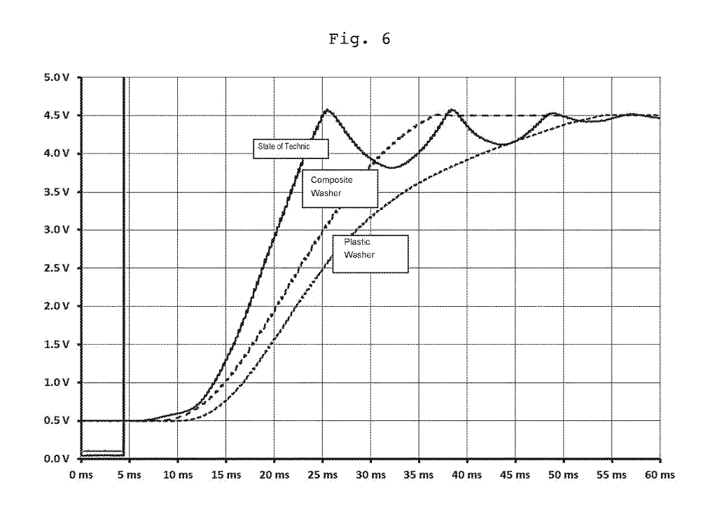

FIG. 5 shows an example of quasi-static torque measurements of an actuator 3 according to the invention equipped with such a friction means 12. FIG. 6 shows the change in response time in an open loop, for two materials of the friction washers 12 and the dynamic behavior to quantify the stick-slip effect, compared to the prior art with an actuator equipped with a thrust ball bearing. Composite type washers 12 have response times only 1.5 times higher than the state of the art solution and thus remain compatible with the requirements of the application.

Another important effect of the solution shown in FIG. 6 is the lack of bounce upon the abutment at the end of the stroke. The shock is much weaker upon the functional abutment of the application (valve closed) with an actuator 3 equipped with a washer 12 than with an actuator equipped with a ball bearing. The increase in the axial stress on the washer 12, when getting closer to the end of the stroke, automatically induces an increase in the friction torque. In case of open loop driving, this is a very good way to slow the rotor when getting closer to the end of the stroke and to reduce the impact speed of inertia in motion on the stops of the application. The integrity of the system driven by the actuator is thus preserved without resorting to complex strategies of the “soft landing” type.

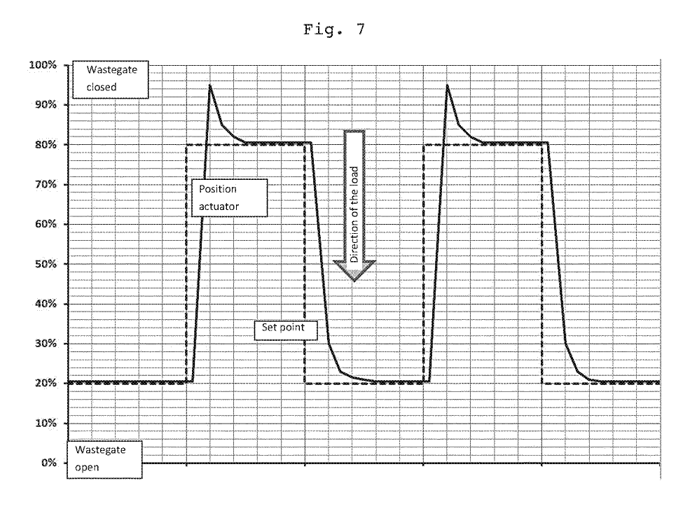

A special strategy for a closed loop driving the actuator 3 shown in FIG. 7, with docking always in the direction of the load, therefore in the opening direction, makes it possible to further improve the performances. Having the friction torque induced by the friction washer 12 always so directed as to help (and not oppose) the actuator 3 is guaranteed. With this driving mode, the power consumed by the coils 15 of the stator 11 for holding the rotor 10 in position is significantly reduced. The software of the regulator controlling the positioning of the actuator 3 is thus so adapted that each docking into a fixed position is performed in the direction of the load. As the relief valves for turbo-compressors always oppose the flow of gas leaving the combustion chamber, the detected load is always oriented in the same direction, i.e. towards the opening. Thus, when the actuator 3 moves the moving element 5 of the turbo-compressor through the kinematics 4 of an opening position to a closed position, the regulator instructs the actuator 3 to go slightly beyond the target position (to voluntarily make an overshoot/go past a set point) in order to be able, right afterwards, to return to the target position in the direction of the load (to cancel the overshoot) and thus to take advantage of the friction introduced by the washer 12 for reducing the power consumed by the coils 15 of the stator 11 for holding the rotor 10 in position. When the actuator moves the moving element 5 of the turbo-compressor through the kinematics 4 from a closed position to an open position, the regulator instructs the actuator 3 to slightly stabilize ahead of the target position (to voluntarily make an undershoot/a stop ahead of the set point) in order to be able, right afterwards, to reach the target position in the direction of the load and thus to take advantage of the friction introduced by the washer 12 to reduce the power consumed by the coils 15 of the stator 11 for holding the rotor 10 in position.

1. An electromagnetic actuator intended in particular to drive a relief valve for a turbo-compressor, with said actuator comprising a fixed element formed by a first magnetic stator circuit made of a material with a high magnetic permeability excited by at least one excitation coil, and a moving member made of a thin part, with said magnetised thin part being alongside a second magnetic circuit made of a material with a high magnetic permeability, with said moving member being provided with a coupling axle, with said fixed and moving members being attracted against one another under the combined magnetic effect of the magnetised part and the excitation coil, said fixed member and the moving member being connected by a frictional mechanical connector of a pure sliding type, in that said connector is a system, directly incorporated in the actuator, for the mechanical damping of the external disturbances applied to the valve, and said connector has a frictional mechanical characteristic of a stick-slip type depending on the relative position of said moving and fixed members and on the current flowing in the coil.

2. An electromagnetic actuator according to claim 1, wherein said frictional mechanical connector includes a blade inserted between said moving member and said fixed member.

3. An electromagnetic actuator according to claim 1, wherein said frictional mechanical connector including a pair of two stacked blades.

4. An electromagnetic actuator according to claim 1, wherein said thin part includes a magnetised disk and said actuator is a rotary actuator.

5. An electromagnetic actuator according to claim 1, wherein said thin part includes a rectangular magnet magnetized in a thickness direction and said actuator is a linear actuator.

6. An electromagnetic rotary actuator according to claim 2, wherein said inserted blades include friction washers.

7. An electromagnetic actuator according to claim 1, wherein said frictional mechanical connector has a static friction greater than a dynamic friction.

8. An electromagnetic actuator according to claim 1, wherein said frictional mechanical connector is so configured as to exert a friction torque greater than or equal to a maximum variable disturbing torque detected by said actuator.

9. An electromagnetic actuator according to claim 2, wherein said frictional mechanical connector is made of a composite material of a metal/polymer type.

10. An electromagnetic actuator according to claim 9, wherein said frictional mechanical connector has a structure comprising a rigid support made of polytetrafluoroethylene (PTFE)-coated steel containing a mixture of fibers.

11. An electromagnetic actuator according to claim 10, wherein said rigid support is sintered with a porous bronze layer impregnated and coated with a sliding layer.

12. An electromagnetic actuator according to claim 8, wherein said frictional connector is integrally made of plastic material.

13. An electromagnetic actuator according to claim 1, further comprising a regulator which drives said actuator in a closed loop and which instructs same to go slightly beyond a target position to voluntarily go past a set point in order to be able, right afterwards, to return to a target position in a direction of a load when said actuator moves said valve from an open position to a closed position; and said regulator which drives said actuator in a closed loop instructs same to slightly stabilize ahead of such target position by voluntarily stopping ahead of said set point, to be able to reach, right afterwards, said target position in said direction of said load when said actuator moves said valve from a closed position to an open position.
